(19) United States
(12) Patent Application Publication
(10) Pub. No.: US 2024/0270879 A1
(43) Pub. Date: Aug. 15, 2024

(54) CATALYST FOR COPOLYMERIZATION OF ETHYLENE AND METHYL METHACRYLATE, AND APPLICATION THEREOF

(71) Applicant: PetroChina Company Limited, Beijing (CN)

(72) Inventors: Qian CHEN, Beijing (CN); Danfeng ZHANG, Beijing (CN); Jincheng LIU, Beijing (CN); Maoyu ZHAO, Beijing (CN); Meng GAO, Beijing (CN); Jian CUI, Beijing (CN); Xianming XU, Beijing (CN); Ben NIU, Beijing (CN); Wenpeng LI, Beijing (CN); Yonggang JI, Beijing (CN)

(21) Appl. No.: 18/617,270

(22) Filed: Mar. 26, 2024

Related U.S. Application Data
(63) Continuation of application No. PCT/CN2022/138647, filed on Dec. 13, 2022.

(30) Foreign Application Priority Data
Dec. 31, 2021 (CN) 202111675304.4

(51) Int. Cl. C08F 4/70; C08F 2/06; C08F 4/602; C08F 210/02; C08F 220/14

(52) U.S. Cl. CPC C08F 4/7098; C08F 2/06; C08F 4/6028; C08F 4/7083; C08F 210/02; C08F 220/14; C08F 2400/04; C08F 2410/04

(57) ABSTRACT

The present application provides a catalyst for copolymerization of ethylene and methyl methacrylate and an application thereof. The catalyst includes a main catalyst, and the main catalyst is obtained by compounding a compound of formula (I) and a compound of formula (II); a mole ratio of the compound of formula (I) to the compound of formula (II) is (1:49) to (49:1). The catalyst has an excellent catalytic activity, and a copolymer of ethylene and methyl methacrylate with a high molecular weight can be obtained, with a weight average molecular weight of not less than 1×10⁵ g/mol.

### CROSS-REFERENCE TO RELATED APPLICATION

This application is a continuation of International Application No. PCT/CN2022/138647, filed on Dec. 13, 2022, which claims priority to Chinese Patent Application No. 202111675304.4, filed on Dec. 31, 2021. Both of the aforementioned patent applications are hereby incorporated by reference in their entireties.

### TECHNICAL FIELD

The application belongs to the field of olefin polymerization, and relates to a catalyst for copolymerization of ethylene and methyl methacrylate and its application.

### BACKGROUND

Compared with traditional polyethylene, the functional polyethylene obtained by copolymerization of ethylene and polar methacrylic acid monomer has better compatibility, adhesion, dyeability and printability. However, the coordination copolymerization of ethylene and methyl methacrylate is a technical problem, which is mainly due to large steric hindrance of methyl methacrylate compared with other polar acrylate monomers. This leads to poor copolymerization activity when interacting with an active center and low molecular weight of the copolymer, making it difficult to control an insertion rate of methyl methacrylate in the copolymer. The existing copolymerization technology of ethylene and methyl methacrylate mainly uses a post-transition metal catalyst, which can achieve the copolymerization of ethylene and methyl methacrylate under the condition of a molar ratio of aluminum oxide as a co catalyst to the main catalyst ≤1000:1. However, the molecular weight of the resulting copolymer is low, usually only 1×10⁴ g/mol.

Therefore, how to synthesize a copolymer of ethylene and methyl methacrylate with high molecular weight is an urgent problem to be solved in the art.

### SUMMARY

The present application provides a catalyst for copolymerization of ethylene and methyl methacrylate, which is used by compounding a compound of formula (I) having an a-diimine late-transition metal complex structure and a compound of formula (II) having a bissalicylaldiminato late-transition metal complex in a specific mole ratio range. The catalyst is used to catalyze a copolymerization reaction of methyl methacrylate and ethylene, and a copolymer of ethylene and methyl methacrylate with a molecular weight of not less than 1×10⁵ g/mol can be obtained.

The present application also provides a copolymerization method of ethylene and methyl methacrylate, which can obtain a copolymer of ethylene and methyl methacrylate with a high molecular weight of not less than 1×10⁵ g/mol. In addition, the method can complete a copolymerization of ethylene and methyl methacrylate under a relatively low reaction temperature and reaction pressure within a relatively short time, which has the advantages of mild reaction conditions and high efficiency.

The present application also provides a copolymer of ethylene and methyl methacrylate, which has the advantages of high molecular weight and adjustable insertion rate of methyl methacrylate.

The present application provides a catalyst for copolymerization of ethylene and methyl methacrylate. The catalyst includes a main catalyst, which is obtained by compounding a compound of formula (I) and a compound of formula (II);
a structure of the compound of formula (I) is:

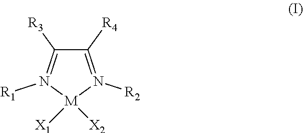

where, R₁ and R₂ are each independently selected from substituted aryl, a substituent being selected from at least one of C1-C6 alkyl and C1-C6 alkoxy;
R₃ and R₄ are each independently selected from hydrogen and C1-C4 alkyl;
M is selected from Ni or Pd;
X₁ and X₂ are each independently selected from at least one of halogen, C1-C4 alkyl, aryl, C2-C4 ether and C1-C4 nitrile;
a structure of the compound of formula (II) is:

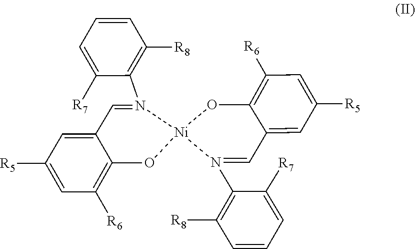

where, R₅ and R₆ are each independently selected from at least one of hydrogen, methyl, ethyl, dimethylamino, diethylamino, amino, hydroxyl, and C1-C4 alkoxy;
R₇ and R₅ are each independently selected from at least one of hydrogen, C1-C4 alkyl, C1-C4 dialkylamino, amino, hydroxyl, and C1-C4 alkoxy;
a mole ratio of the compound of formula (I) to the compound of formula (II) is (1:49) to (49:1).

For the catalyst as mentioned above, the mole ratio of the compound of formula (I) to the compound of formula (II) is (1:10) to (10:1).

For the catalyst as mentioned above, the catalyst further includes a co-catalyst, and the co-catalyst is selected from aluminoxane.

For the catalyst as mentioned above, the co-catalyst is selected from at least one of methylaluminoxane, trialkylaluminum, and alkylaluminium halide.

For the catalyst as mentioned above, a mole ratio of metal element in the main catalyst to aluminum element in the co-catalyst is 1:(50-1000).

For the catalyst as mentioned above, the mole ratio of the metal element in the main catalyst to the aluminum element in the co-catalyst is 1:(100-500).

The present application also provides a copolymerization method of ethylene and methyl methacrylate, which utilizes the above-mentioned catalyst to carry out a copolymerization reaction.

For the copolymerization method as mentioned above, the copolymerization method includes: subjecting ethylene and methyl methacrylate to the copolymerization reaction under a catalysis of the catalyst;
a pressure of the copolymerization reaction is ≤10 MPa, and a temperature of the copolymerization reaction is ≤100° C.

For the copolymerization method as mentioned above, a solvent of the copolymerization reaction is selected from at least one of toluene, n-hexane, dichloromethane, and dichloroethane.

The present application also provides a copolymer of ethylene and methyl methacrylate, and the copolymer is prepared by the copolymerization method as mentioned above, and has a weight average molecular weight of ≥1×10⁵ g/mol.

In the catalyst used for the copolymerization of ethylene and methyl methacrylate of the present application, by compounding the compound of formula (I) having an a-diimine late-transition metal complex structure with the compound of formula (II) having a bissalicylaldiminato late-transition metal complex, the two compounds can synergize with each other to promote the copolymerization of ethylene and methyl methacrylate within a specific mole ratio range, thereby obtaining a high molecular weight copolymer of ethylene and methyl methacrylate.

The copolymerization method of ethylene and methyl methacrylate of the present application can obtain the copolymer of ethylene and methyl methacrylate with a weight average molecular weight of not less than 1×10⁵ g/mol. In addition, by using this method, the copolymerization of ethylene and methyl methacrylate can be completed under a relatively low reaction temperature and reaction pressure within a relatively short time, which has the advantages of mild reaction conditions and high efficiency and is beneficial to industrial applications.

The copolymer of ethylene and methyl methacrylate of the present application has the advantages of the weight average molecular weight of not less than 1×10⁵ g/mol, and adjustable insertion rate of methyl methacrylate.

### DESCRIPTION OF EMBODIMENTS

The present application will be further described in detail below with reference to specific embodiments. It should be understood that the following examples are only for exemplarily describing and explaining the present application, and should not be construed as limiting the protection scope of the present application. All technologies implemented based on the above contents of the present application are encompassed within the protection scope of the present application.

A first aspect of the present application provides a catalyst for copolymerization of ethylene and methyl methacrylate, including a main catalyst, and the main catalyst is obtained by compounding a compound of formula (I) and a compound of formula (II);
a structure of the compound of formula (I) is:

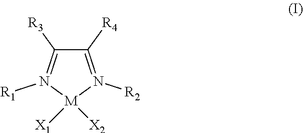

where, R₁ and R₂ are each independently selected from substituted aryl, a substituent being selected from at least one of C1-C6 alkyl and C1-C6 alkoxy;
R₃ and R₄ are each independently selected from hydrogen and C1-C4 alkyl;
M is selected from Ni or Pd;
X₁ and X₂ are each independently selected from at least one of halogen, C1-C4 alkyl, aryl, C2-C4 ether and C1-C4 nitrile;
a structure of the compound of formula (II) is:

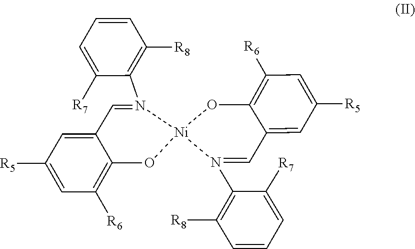

where, R₅ and R₆ are each independently selected from at least one of hydrogen, methyl, ethyl, dimethylamino, diethylamino, amino, hydroxyl, and C1-C4 alkoxy;
R₇ and R₈ are each independently selected from at least one of hydrogen, C1-C4 alkyl, C1-C4 dialkylamino, amino, hydroxyl, and C1-C4 alkoxy;
a mole ratio of the compound of formula (I) to the compound of formula (II) is (1:49)-(49:1).

The substituted aryl refers to an aryl attached with a substituent. Specifically, the aryl may be phenyl, naphthyl, biphenyl and the like. The present application does not limit a substitution position of the substituent on the aryl. For example, it may be at an ortho position of a diimine structure, or at a para position of the diimine structure. C1-C6 alkyl refers to a branched alkyl group or a linear alkyl group with 1 to 6 carbons, for example, it may be methyl, ethyl, propyl, isopropyl, tert-butyl, etc.; C1-C6 alkoxy group refers to a branched alkoxy group or a linear alkoxy group with 1 to 6 carbon atoms, for example, it may be methoxy, ethoxy, isopropoxy, etc. Similarly, a C1-C4 alkyl group refers to a linear alkyl group or a branched alkyl group with 1 to 4 carbon atoms, and a C1-C4 alkoxy group refers to a linear alkoxy group or a branched alkoxy group with 1 to 4 carbon atoms. The C1-C4 dialkylamino group refers to a substituent in which an amino group is substituted by two C1-C4 linear or linear alkyl groups, for example, it may be dimethylamino, diethylamino, dipropylamino and the like. The halogen is one of fluorine, chlorine, bromine and iodine.

The inventors' research have found that the compound of formula (I) and the compound of formula (II) are compounded in a mole ratio range of (1:49) to (49:1) to form a main catalyst, which can catalyze the copolymerization of ethylene and methyl methacrylate to obtain a copolymer of ethylene and methyl methacrylate with a molecular weight of not less than 1×10⁵ g/mol. The reason may be that the compound of formula (I) is an a-diimine late-transition metal complex, and the compound of formula (II) is a bissalicylaldiminato late-transition metal complex, the structures of the two can be matched and coordinated with each other, which can ensure that a reactivity ratio of ethylene and methyl methacrylate is within an appropriate range, and can maximize the advantages of two compounds with different structures. In addition, both the compound of formula (I) and the compound of formula (II) are attached with an electron-donating group, which can weaken a possibility that a metal center is attacked by an ester group of methyl methacrylate, and at the same time increase a possibility of inserting the C═C double bond of methyl methacrylate into the empty orbit of the metal center and shorten coordination time between the double bond and an active center, thereby obtaining a high-molecular-weight copolymer of ethylene and methyl methacrylate.

Further, when the mole ratio of the compound of formula (I) to the compound of formula (II) is (1:10)-(10:1), the catalytic activity of the catalyst, the weight average molecular weight of the copolymer and the insertion rate of methyl methacrylate are all at a more balanced level.

It can be understood that the catalyst of the present application also includes a co-catalyst. Specifically, the co-catalyst of the present application is selected from aluminoxane, which can alkylate the main catalyst, and can also take away the halogen or alkyl in the main catalyst to form a cationic active center, and meantime can also play a role of a non-coordinating equilibrium ion, each being beneficial to the increase of the molecular weight of the copolymer.

Further, the co-catalyst is selected from at least one of methylaluminoxane (MAO), alkylaluminum, and alkylaluminium halide. The co-catalyst may be obtained from a wide range of sources and have a low cost, and may also assist the main catalyst to further increase the molecular weight of the obtained copolymer of ethylene and methyl methacrylate.

In a specific implementation, when a mole ratio of the metal element in the main catalyst to the aluminum element in the co-catalyst is 1:(50-1000), the catalyst exhibits excellent copolymerization activity between ethylene and methyl methacrylate.

Further, when the mole ratio of the metal element in the main catalyst to the aluminum element in the co-catalyst is 1:(100-500), it will be more beneficial to improve the copolymerization activity of the catalyst.

A second aspect of the present application provides a copolymerization method of the ethylene and methyl methacrylate, which uses the catalyst for copolymerization of ethylene and methyl methacrylate provided in the first aspect of the present application as the copolymerization catalyst.

The above copolymerization method has excellent copolymerization activity, and can obtain a copolymer of ethylene and methyl methacrylate with a molecular weight of not less than 1×10⁵ g/mol. In addition, this method can allow the copolymerization reaction to be carried out at a relatively low polymerization temperature and small polymerization pressure, i.e. the reaction condition is relatively mild, which is favorable for industrial application.

The above-mentioned copolymerization method can also control the insertion rate of methyl methacrylate in the copolymer by controlling factors such as a copolymerization pressure, a mole ratio of a raw material to the catalyst, a copolymerization temperature, and a copolymerization time. In the specific production process, the insertion rate of methyl methacrylate in the copolymer may be regulated accordingly based on the requirements of different products on the ester content.

In a specific implementation, the above-mentioned copolymerization method includes: carrying out a copolymerization reaction of ethylene and methyl methacrylate under a catalysis of a catalyst, where a pressure of the copolymerization reaction is ≤10 MPa, and a temperature of the copolymerization reaction is ≤100° C. The copolymerization reaction of the present application can be carried out smoothly in this pressure and temperature range, which reduces the severity of the copolymerization reaction.

Further, the above copolymerization reaction can be carried out in a solvent system. Specifically, the solvent may be selected from at least one of toluene, n-hexane, dichloromethane, and dichloroethane. Among them, toluene, dichloromethane, and dichloroethane belong to polar solvents, which is beneficial to the insertion of methyl methacrylate and improvement of the activity of polar copolymerization. The above-mentioned copolymerization reaction may also be carried out by using n-hexane, which is a commonly used solvent in industry and has the advantages of easy availability and low toxicity.

A third aspect of the present application provides a copolymer of ethylene and methyl methacrylate, which is prepared by the copolymerization method provided in the second aspect of the present application.

The copolymer of this application is prepared by the copolymerization method provided by the second aspect of the present application, so it has a relatively high molecular weight, which can meet the deployment requirements of existing resin processing equipment and commercial plastics, and has an adjustable insertion rate of methyl methacrylate and a wide application range.

The catalyst for copolymerization of ethylene and methyl methacrylate provided by the present application will be further described in detail below with reference to specific embodiments.

It should be noted that, in the following embodiments, unless otherwise specified, all raw materials used are commercially available or can be prepared by conventional methods, and the experimental methods without specified conditions are conventional methods and conventional conditions that are well known in the art.

### Embodiment 1

1. The main catalyst of the catalyst used for the copolymerization of ethylene and methyl methacrylate in the present embodiment is obtained by compounding compound 1 and compound 2 at a mole ratio of 1:49, and the main catalyst obtained by such compounding is labeled as main catalyst A.

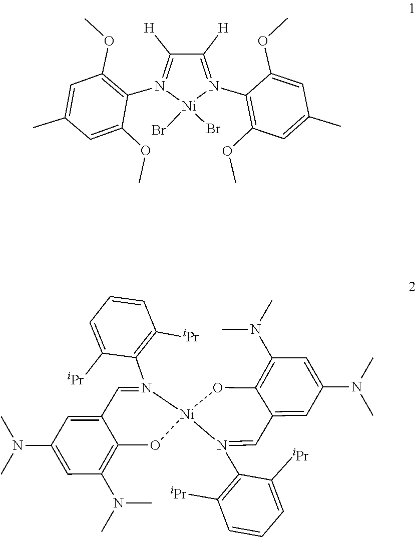

2. The preparation method of the copolymer of ethylene and methyl methacrylate in the present embodiment includes the following steps:

1) in a 150 mL clean and dry autoclave, adding 50 mL of toluene and 40 mol of the main catalyst A under an ethylene atmosphere; then feeding ethylene until the pressure is 0.05 MPa, and placing the reaction autoclave in an oil bath at 60° C. (copolymerization temperature) and performing electromagnetic stirring; adding 50 mmol of methyl methacrylate, 7.85 mL of MAO (concentration: 1.53 mol/L) under stirring, where Al/Ni mole ratio=300:1; continuing to feed ethylene until the pressure reaches 4 MPa (copolymerization pressure) and performing reaction for 1 h, then stopping the feeding of ethylene;

2) relieving pressure; using a hydrochloric acid ethanol solution with a volume concentration of 5% for processing; then washing, filtering, and drying to obtain a copolymer of ethylene and methyl methacrylate.

### Embodiment 2

1. The main catalyst of the catalyst used for the copolymerization of ethylene and methyl methacrylate in the present embodiment is basically the same as that in Embodiment 1, except that the mole ratio of compound 1 to compound 2 is 49:1, and the main catalyst obtained by compounding is labeled as main catalyst B.

2. The preparation method of the copolymer of ethylene and methyl methacrylate in the present embodiment is basically the same as that in Embodiment 1, except that the main catalyst A is replaced by the main catalyst B.

### Embodiment 3

1. The main catalyst of the catalyst used for the copolymerization of ethylene and methyl methacrylate in the present embodiment is basically the same as that in Embodiment 1, except that the mole ratio of compound 1 to compound 2 is 1:1, and the main catalyst obtained by compounding is labeled as main catalyst C.

2. The preparation method of the copolymer of ethylene and methyl methacrylate in the present embodiment is basically the same as that in Embodiment 1, except that the main catalyst A is replaced by the main catalyst C.

### Embodiment 4

1. The main catalyst of the catalyst used for the copolymerization of ethylene and methyl methacrylate in the present embodiment is basically the same as that in Embodiment 1, except that the mole ratio of compound 1 to compound 2 is 3:1, and the main catalyst obtained by compounding is labeled as main catalyst D.

2. The preparation method of the copolymer of ethylene and methyl methacrylate in the present embodiment is basically the same as that in Embodiment 1, except that the main catalyst A is replaced by main catalyst D.

### Embodiment 5

1. The main catalyst of the catalyst used for the copolymerization of ethylene and methyl methacrylate in the present embodiment is consistent with that in Embodiment 3.

2. The preparation method of the copolymer of ethylene and methyl methacrylate in the present embodiment is basically the same as that in Embodiment 3, except that 13 mL of MAO (1.53 mol/L) is added, and the mole ratio of Al/Ni is 500:1.

### Embodiment 6

1. The main catalyst of the catalyst used for the copolymerization of ethylene and methyl methacrylate in the present embodiment is basically the same as that in Embodiment 1, except that the mole ratio of compound 1 to compound 2 is 10:1, and the main catalyst obtained by compounding is labeled as main catalyst E.

2. The preparation method of the copolymer of ethylene and methyl methacrylate in the present embodiment is basically the same as that in Embodiment 1, except that the main catalyst A is replaced by main catalyst E.

### Embodiment 7

1. The main catalyst of the catalyst used for the copolymerization of ethylene and methyl methacrylate in the present embodiment is basically consistent with Embodiment 1, except that the mole ratio of compound 1 to compound 2 is 1:10, and the main catalyst obtained by compounding is labeled as main catalyst F.

2. The preparation method of the copolymer of ethylene and methyl methacrylate in the present embodiment is basically the same as that in Embodiment 3, except that MAO is replaced by aluminum sesquiethyl and the main catalyst C is replaced by main catalyst F.

### Embodiment 8

1. The main catalyst of the catalyst used for the copolymerization of ethylene and methyl methacrylate in the present embodiment is consistent with that in Embodiment 3.

2. The preparation method of the copolymer of ethylene and methyl methacrylate of the present embodiment is basically the same as that in the Embodiment 7, except that toluene is replaced by dichloromethane and the copolymerization reaction pressure is changed from 4 MPa to 5 MPa.

### Embodiment 9

1. The main catalyst of the catalyst used for the copolymerization of ethylene and methyl methacrylate in the present embodiment is consistent with that in Embodiment 8.

2. The preparation method of the copolymer of ethylene and methyl methacrylate in the present embodiment is basically the same as that in Embodiment 8, except that dichloromethane is replaced by dichloroethane, and the copolymerization reaction time is changed from 1 h to 2 h.

### Embodiment 10

1. The main catalyst of the catalyst used for the copolymerization of ethylene and methyl methacrylate in the present embodiment is consistent with that in Embodiment 9.

2. The preparation method of the copolymer of ethylene and methyl methacrylate in the present embodiment is basically the same as that in Embodiment 9, except that dichloroethane is replaced by a mixed solution of dichloroethane and toluene, where a volume ratio of dichloroethane to toluene in the mixed solution is 1:1.

### Embodiment 11

1. The main catalyst of the catalyst used for the copolymerization of ethylene and methyl methacrylate in the present embodiment is obtained by compounding compound 3 and compound 4 at a mole ratio of 49:1, and the main catalyst obtained by such compounding is labeled as main catalyst G.

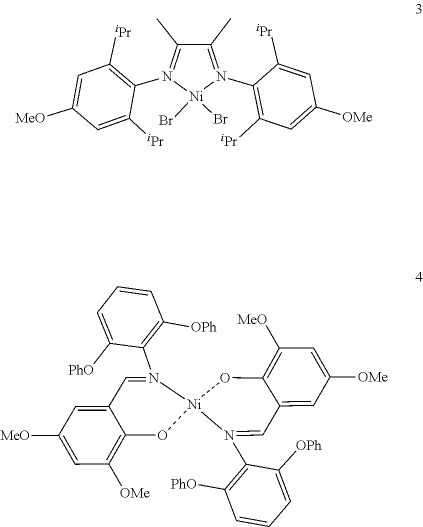

2. The preparation method of the copolymer of ethylene of and methyl methacrylate in the present embodiment includes the following steps:

1) in a 150 mL clean and dry autoclave, adding 50 mL of toluene and 40 μmol of the main catalyst G under an ethylene atmosphere; then feeding ethylene until the pressure is 0.05 MPa, and placing the reaction autoclave in an oil bath at 40° C. and performing electromagnetic stirring; adding 50 mmol of methyl methacrylate and 7.85 mL of MAO (concentration: 1.53 mol/L) under stirring, where Al/Ni mole ratio=300:1; continuing to feed ethylene until the pressure reaches 3 MPa and performing reaction for 1 h, then stopping feeding ethylene.
2) relieving pressure; using a hydrochloric acid ethanol solution with a volume concentration of 5% for processing; then washing, filtering, and drying to obtain 284 g of the copolymer of ethylene and methyl methacrylate.

### Embodiment 12

1. The main catalyst of the catalyst used for the copolymerization of ethylene and methyl methacrylate in the present embodiment is basically the same as that in Embodiment 11, except that the mole ratio of compound 3 to compound 4 is 1:49, and the main catalyst obtained by compounding is labeled as main catalyst H.

2. The preparation method of the copolymer of ethylene and methyl methacrylate in the present embodiment is basically the same as that in Embodiment 11, except that the main catalyst G is replaced by the main catalyst H.

### Embodiment 13

1. The main catalyst of the catalyst used for the copolymerization of ethylene and methyl methacrylate in the present embodiment is basically the same as that in Embodiment 11, the difference is that the mole ratio of compound 3 to compound 4 is 1:1, and the main catalyst obtained by compounding is labeled as main catalyst I.

2. The preparation method of the copolymer of ethylene and methyl methacrylate in the present embodiment is basically the same as that in Embodiment 11, the difference is that the main catalyst G is replaced by the main catalyst I.

### Embodiment 14

1. The main catalyst of the catalyst used for the copolymerization of ethylene and methyl methacrylate in the present embodiment is basically the same as that in Embodiment 11, the difference is that the mole ratio of compound 3 to compound 4 is 30:1, and the main catalyst obtained by compounding is labeled as main catalyst J.

2. The preparation method of the copolymer of ethylene and methyl methacrylate in the present embodiment is basically the same as that in Embodiment 11, the difference is that the main catalyst G is replaced by the main catalyst J.

### Embodiment 15

1. The main catalyst used in the present embodiment for the catalyst for copolymerization of ethylene and methyl methacrylate in the present embodiment is basically the same as that in Embodiment 11, the difference is that the mole ratio of compound 3 to compound 4 is 10:1, and the main catalyst obtained by compounding is labeled as main catalyst K.

2. The preparation method of the copolymer of ethylene and methyl methacrylate in the present embodiment is basically the same as that in Embodiment 11, the difference is that the main catalyst G is replaced by the main catalyst K, MAO is replaced by aluminum sesquiethyl, and the copolymerization reaction pressure is 2 MPa, and the copolymerization reaction time is 2 h.

### Embodiment 16

1. The main catalyst of the catalyst used for the copolymerization of ethylene and methyl methacrylate in the present embodiment is basically the same as that in Embodiment 11, the difference is that the mole ratio of compound 3 to compound 4 is 1:10, and the main catalyst obtained by compounding is labeled as main catalyst L.

2. The preparation method of the copolymer of ethylene and methyl methacrylate in the present embodiment is basically the same as that in Embodiment 13, the difference is that 7.85 mL of MAO (concentration: 1.53 mol/L) and Al/Ni mole ratio=300:1 are replaced with 13 mL of aluminum sesquiethyl (1.53 mol/L) and Al/Ni mole ratio=500:1 respectively, the copolymerization reaction pressure is 2 MPa, and the copolymerization reaction time is 2 h.

### Embodiment 17

1. The main catalyst of the catalyst used for the copolymerization of ethylene and methyl methacrylate in the present embodiment is basically the same as that in Embodiment 16, the difference is that the mole ratio of compound 3 to compound 4 is 2:1, and the main catalyst obtained by compounding is labeled as main catalyst M.

2. The preparation method of the copolymer of ethylene and methyl methacrylate in the present embodiment is basically the same as that in Embodiment 16, the difference is that toluene is replaced by n-hexane, the copolymerization temperature is 60° C., and the copolymerization pressure is 3 MPa.

### Embodiment 18

1. The main catalyst of the catalyst used for the copolymerization of ethylene and methyl methacrylate in the present embodiment is consistent with that in Embodiment 13.

2. The preparation method of the copolymer of ethylene and methyl methacrylate in the present embodiment is basically the same as that in Embodiment 13, the difference is that toluene is replaced by a mixed solution of n-hexane and dichloroethane, where, a volume ratio of n-hexane to dichloroethane ethane is 1:1, MAO is replaced by aluminum sesquiethyl, and the copolymerization reaction pressure is 5 MPa.

### Embodiment 19

1. The main catalyst of the catalyst used for the copolymerization of ethylene and methyl methacrylate in the present embodiment is consistent with that in Embodiment 13.

2. The preparation method of the copolymer of ethylene and methyl methacrylate in the present embodiment is basically the same as that in Embodiment 13, the difference is that toluene is replaced by a mixed solution of n-hexane and dichloroethane, where, a volume ratio of n-hexane to dichloroethane is 1:2, MAO is replaced by aluminum sesquiethyl, the copolymerization reaction pressure is 10 MPa, and the copolymerization temperature is 60° C., and the amount of methyl methacrylate added is 60 mmol.

### Embodiment 20

1. The main catalyst of the catalyst used for the copolymerization of ethylene and methyl methacrylate in the present embodiment is consistent with that in Embodiment 13.

2. The preparation method of the copolymer of ethylene and methyl methacrylate in the present embodiment is basically the same as that in Embodiment 13, the difference is that toluene is replaced by dichloromethane, MAO is replaced by aluminum sesquiethyl, the copolymerization reaction pressure is 5 MPa, and the copolymerization temperature is 80° C., and the amount of methyl methacrylate added is 30 mmol.

### Embodiment 21

1. The main catalyst of the catalyst used for the copolymerization of ethylene and methyl methacrylate in the present embodiment is obtained by compounding compound 5 and compound 6 at a mole ratio of 49:1, and the main catalyst obtained by such compounding is labeled as main catalyst N.

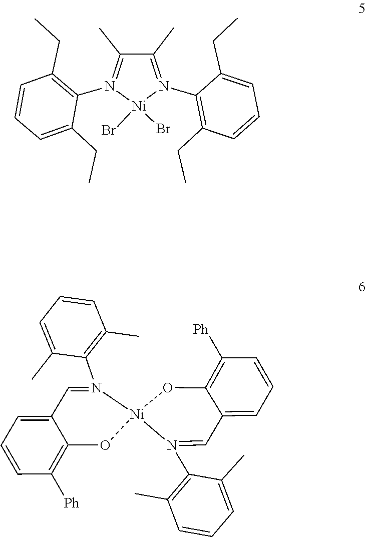

2. The preparation method of the copolymer of ethylene of and methyl methacrylate in the present embodiment includes the following steps:

1) in a 150 mL clean and dry autoclave, adding 50 mL of toluene and 40 mol of the main catalyst N under an ethylene atmosphere; then feeding ethylene until the pressure is 0.05 MPa, and placing the reaction autoclave in an oil bath at 60° C. and performing electromagnetic stirring; adding 50 mmol of methyl methacrylate and 7.5 mL of aluminum sesquiethyl (1.53 mol/L) under stirring, where Al/Ni mole ratio is 300:1; continuing to feed ethylene until under the pressure reaches 5 MPa and performing reaction for 2 h, then stopping feeding ethylene;

2) relieving pressure; using a hydrochloric acid ethanol solution with a volume concentration of 5% for processing; then washing, filtering, and drying to obtain the copolymer of ethylene and methyl methacrylate.

### Embodiment 22

1. The main catalyst of the catalyst used for the copolymerization of ethylene and methyl methacrylate in the present embodiment is basically the same as that in Embodiment 21, the difference is that the mole ratio of compound 5 to compound 6 is 1:49, and the main catalyst obtained by compounding is labeled as main catalyst O.

2. The preparation method of the copolymer of ethylene and methyl methacrylate in the present embodiment is basically the same as that in Embodiment 21, the difference is that the main catalyst N is replaced by the main catalyst O.

### Embodiment 23

1. The main catalyst of the catalyst used for the copolymerization of ethylene and methyl methacrylate in the present embodiment is basically the same as that in Embodiment 21, the difference is that the mole ratio of compound 5 to compound 6 is 1:1, and the main catalyst obtained by compounding is labeled as main catalyst P.

2. The preparation method of the copolymer of ethylene and methyl methacrylate in the present embodiment is basically the same as that in Embodiment 21, the difference is that the main catalyst N is replaced by the main catalyst P.

### Embodiment 24

1. The main catalyst of the catalyst used for the copolymerization of ethylene and methyl methacrylate in the present embodiment is basically the same as that in Embodiment 21, the difference is that the mole ratio of compound 5 to compound 6 is 10:1, and the main catalyst obtained by compounding is labeled as main catalyst Q.

2. The preparation method of the copolymer of ethylene and methyl methacrylate in the present embodiment is basically the same as that in Embodiment 21, the difference is that the main catalyst N is replaced by the main catalyst Q.

### Embodiment 25

1. The main catalyst of the catalyst used for the copolymerization of ethylene and methyl methacrylate in the present embodiment is basically the same as that in Embodiment 21, the difference is that the mole ratio of compound 5 to compound 6 is 1:10, and the main catalyst obtained by compounding is labeled as main catalyst R.

2. The preparation method of the copolymer of ethylene and methyl methacrylate in the present embodiment is basically the same as that in Embodiment 21, the difference is that the main catalyst N is replaced by the main catalyst R.

### Embodiment 26

1. The main catalyst of the catalyst used for the copolymerization of ethylene and methyl methacrylate in the present embodiment is basically the same as that in Embodiment 21, the difference is that the mole ratio of compound 5 to compound 6 is 1:5, and the main catalyst obtained by compounding is labeled as main catalyst S.

2. The preparation method of the copolymer of ethylene and methyl methacrylate in the present embodiment is basically the same as that in Embodiment 21, the difference is that the main catalyst N is replaced by the main catalyst S, the aluminum sesquiethyl is replaced by MAO, and the temperature of copolymerization reaction is 40° C., and the amount of methyl methacrylate added is 60 mmol.

### Embodiment 27

1. The main catalyst of the catalyst used for the copolymerization of ethylene and methyl methacrylate in the present embodiment is consistent with that in Embodiment 26.

2. The preparation method of the copolymer of ethylene and methyl methacrylate in the present embodiment is basically the same as that in Embodiment 26, the difference is that toluene is replaced by dichloroethane, the amount of MAO added is 13 mL (1.53 mol/L), with Al/Ni mole ratio being 500:1.

### Embodiment 28

1. The main catalyst of the catalyst used for the copolymerization of ethylene and methyl methacrylate in the present embodiment is basically the same as that in Embodiment 27, the difference is that the mole ratio of compound 5 to compound 6 is 2:1, and the main catalyst obtained by compounding is labeled as main catalyst T.

2. The preparation method of the copolymer of ethylene and methyl methacrylate in the present embodiment is basically the same as that in Embodiment 27, the difference is that the main catalyst S is replaced by the main catalyst T, dichloroethane is replaced by toluene, and the copolymerization reaction pressure is 3 MPa, and the copolymerization reaction temperature is 80° C.

### Embodiment 29

1. The main catalyst of the catalyst used for the copolymerization of ethylene and methyl methacrylate in the present embodiment is consistent with that in Embodiment 28.

2. The preparation method of the copolymer of ethylene and methyl methacrylate in the present embodiment is basically the same as that in Embodiment 28, the difference is that toluene is replaced by a mixed solution of dichloromethane and n-hexane, where a volume ratio of dichloromethane to n-hexane is 1:3, and the copolymerization reaction time is 4 h.

### Embodiment 30

1. The main catalyst of the catalyst used for the copolymerization of ethylene and methyl methacrylate in the present embodiment is consistent with that in Embodiment 23.

2. The preparation method of the copolymer of ethylene and methyl methacrylate in the present embodiment is basically the same as that in Embodiment 23, the difference is that toluene is replaced by dichloroethane, 7.5 mL (1.53 mol/L) of aluminum sesquiethyl and Al/Ni mole ratio of 300:1 are replaced by 13 mL of MAO (1.53 mol/L) and Al/Ni mole ratio of 500:1 respectively, the copolymerization reaction time is 6 h, and the amount of methyl methacrylate added is 30 mmol.

### Embodiment 31

1. The main catalyst of the catalyst used for the copolymerization of ethylene and methyl methacrylate in the present embodiment is obtained by compounding compound 7 and compound 8 at a mole ratio of 1:1, and the main catalyst obtained by such compounding is labeled as main catalyst U.

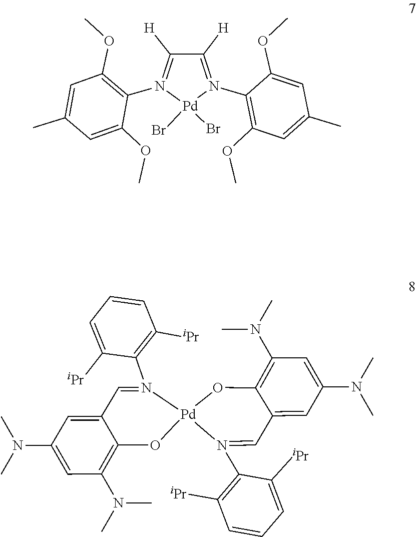

2. The preparation method of the copolymer of ethylene and methyl methacrylate of the present embodiment includes the following steps: in a 150 mL clean and dry autoclave, adding 50 mL of toluene and 40 mol of the main catalyst U under an ethylene atmosphere; then feeding ethylene until the pressure is 0.05 MPa, and placing the reaction autoclave in an oil bath at 60° C. (copolymerization temperature) and performing electromagnetic stirring; and adding 50 mmol of methyl methacrylate and 13 mL of MAO (concentration of 1.53 mol/L) under stirring, where the Al/Ni mole ratio is 500:1; continuing to feed ethylene until the pressure reaches 4 MPa (copolymerization pressure) and performing reaction for 1 h, then stopping feeding ethylene; relieving pressure; using a hydrochloric acid ethanol solution with a volume concentration of 5% for processing; then washing, filtering, and drying to obtain the copolymer of ethylene and methyl methacrylate.

### Embodiment 32

1. The main catalyst of the catalyst used for the copolymerization of ethylene and methyl methacrylate in the present embodiment is obtained by compounding compound 9 and compound 10 at a mole ratio of 49:1, and the main catalyst obtained by such compounding is labeled as main catalyst V.

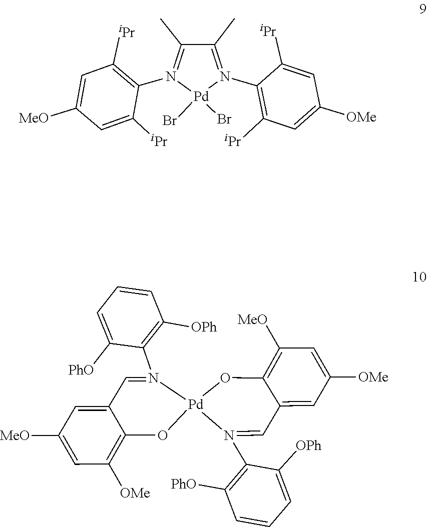

2. The preparation method of the copolymer of ethylene and methyl methacrylate of the present embodiment includes the following steps: in a 150 mL clean and dry autoclave, adding 50 mL of toluene and 40 mol of the main catalyst V under an ethylene atmosphere; then feeding ethylene until the pressure is 0.05 MPa, and placing the reaction autoclave in an oil bath at 40° C. and performing electromagnetic stirring; adding 50 mmol of methyl methacrylate and 7.85 mL of MAO (concentration is 1.53 mol/L) under stirring, where Al/Ni mole ratio is 300:1; continuing to feed ethylene until the pressure reaches 3 MPa and performing reaction for 1 h, then stopping feeding ethylene after; relieving pressure; using a hydrochloric acid ethanol solution with a volume concentration of 5% for processing; then washing, filtering, and drying to obtain 284 g of the copolymer of ethylene and methyl methacrylate.

### Embodiment 33

1. The main catalyst of the catalyst used for the copolymerization of ethylene and methyl methacrylate in the present embodiment is obtained by compounding compound 11 and compound 12 at a mole ratio of 49:1, and the main catalyst obtained by such compounding is labeled as main catalyst W.

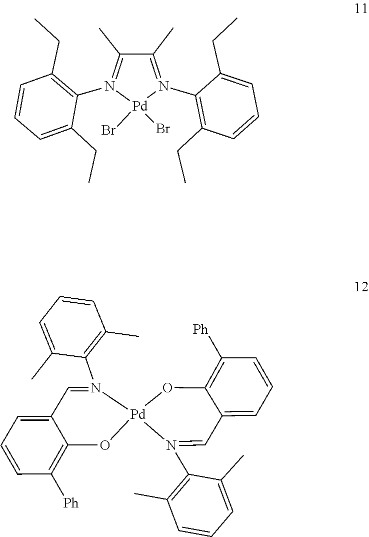

2. The preparation method of the copolymer of ethylene and methyl methacrylate of the present embodiment includes the following steps: in a 150 mL clean and dry autoclave, adding 50 mL of toluene and 40 mol of the main catalyst W under an ethylene atmosphere; then feeding ethylene until the pressure is 0.05 MPa, and placing the reaction autoclave in an oil bath at 60° C. and performing electromagnetic stirring; adding 50 mmol of methyl methacrylate and 7.85 mL of aluminum sesquiethyl (1.53 mol/L) under stirring, where the Al/Ni mole ratio is 300:1; continuing to feed ethylene until the pressure reaches 5 MPa and performing reaction for 2 h, then stopping feeding ethylene; relieving pressure; using a hydrochloric acid ethanol solution with a volume concentration of 5% for processing; then washing, filtering, and drying to obtain the copolymer of ethylene and methyl methacrylate.

### Embodiment 34

1. The main catalyst of the catalyst used in the copolymerization of ethylene and methyl methacrylate in this embodiment is the same as that in Embodiment 3.

2. The preparation method of the copolymer of ethylene and methyl methacrylate of the present embodiment includes the following steps: in a 150 mL clean and dry autoclave, adding 50 mL of toluene and 40 mol of the main catalyst C under an ethylene atmosphere; then feeding ethylene until the pressure is 0.05 MPa, and placing the reaction autoclave in an oil bath at 60° C. and performing electromagnetic stirring, adding 50 mmol of methyl methacrylate and 19.63 mL of MAO (1.53 mol/L) under stirring, where the Al/Ni mole ratio is 750:1; continuing to feed ethylene until the pressure reaches 4 MPa and performing reaction for 1 h, then stopping feeding ethylene; relieving pressure; using a hydrochloric acid ethanol solution with a volume concentration of 5% for processing; then washing, filtering, and drying to obtain the copolymer of ethylene and methyl methacrylate.

### Embodiment 35

1. The main catalyst of the catalyst used in the copolymerization of ethylene and methyl methacrylate in this embodiment is the same as that in Embodiment 3.

2. The preparation method of the copolymer of ethylene and methyl methacrylate of the present embodiment includes the following steps: in a 150 mL clean and dry autoclave, adding 50 mL of toluene and 40 mol of the main catalyst C under an ethylene atmosphere; then feeding ethylene until the pressure is 0.05 MPa, and placing the reaction autoclave in an oil bath at 60° C. and performing electromagnetic stirring; adding 50 mmol of methyl methacrylate and 52.33 mL of MAO (1.53 mol/L) under stirring, where the Al/Ni mole ratio is 2000:1; continuing to feed ethylene until the pressure reaches 4 MPa and performing reaction for 1 h, then stopping feeding ethylene; relieving pressure; using a hydrochloric acid ethanol solution with a volume concentration of 5% for processing; then washing, filtering, and drying to obtain the copolymer of ethylene and methyl methacrylate.

### Comparative Embodiment 1

1. The main catalyst of the catalyst used for the copolymerization of ethylene and methyl methacrylate in the present comparative embodiment is compound 5, labeled as main catalyst Y₁.

2. The preparation method of the copolymer of ethylene and methyl methacrylate of the present embodiment includes the following steps:

1) in a 150 mL clean and dry autoclave, adding 50 mL of toluene and 140 mol of main catalyst Y₁ under an ethylene atmosphere; then feeding ethylene until the pressure is 0.05 MPa, and placing the reaction autoclave in an oil bath at 60° C. and performing electromagnetic stirring; adding 30 mmol of methyl methacrylate, 7.5 mL of MAO (1.53 mol/L) under stirring, where Al/Ni mole ratio is 300:1; continuing to feed ethylene until the pressure is 5 MPa and performing reaction for 1 h, then stopping feeding ethylene.
2) relieving pressure; using a hydrochloric acid ethanol solution with a volume concentration of 5% for processing; then washing, filtering, and drying to obtain the copolymer of ethylene and methyl methacrylate.

### Comparative Embodiment 2

1. The main catalyst used for the copolymerization of ethylene and methyl methacrylate in the present comparative embodiment is compound 6, labeled as main catalyst Y₂.

2. The preparation method of the copolymer of ethylene and methyl methacrylate of the present embodiment includes the following steps:

1) in a 150 mL clean and dry autoclave, adding 50 mL of toluene and 240 mol of main catalyst Y₂ under an ethylene atmosphere; then feeding ethylene until the pressure is 0.05 MPa, and placing the reaction autoclave in an oil bath at 60° C. and performing electromagnetic stirring; adding 30 mmol of methyl methacrylate, 7.5 mL of MAO (1.53 mol/L) under stirring, where Al/Ni mole ratio is 300:1; continuing to feed ethylene until the pressure is 5 MPa and performing reaction for 1 h, then stopping feeding ethylene;

2) relieving pressure; using a hydrochloric acid ethanol solution with a volume concentration of 5% for processing; then washing, filtering, and drying to obtain the copolymer of ethylene and methyl methacrylate.

### Comparative Embodiment 3

1. The main catalyst used for the copolymerization of ethylene and methyl methacrylate in the present comparative embodiment is compound 13, labeled as main catalyst Y₃.

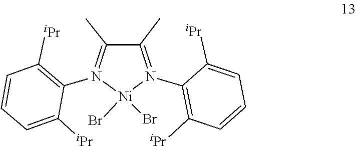

2. The preparation method of the copolymer of ethylene of and methyl methacrylate in the present embodiment includes the following steps:

1) in a 150 mL clean and dry autoclave, adding 50 mL of toluene and 40 mol of the main catalyst Y₃ under an ethylene atmosphere; then feeding ethylene until the pressure is 0.05 MPa, and placing the reaction autoclave in an oil bath at 60° C. and performing electromagnetic stirring; adding 50 mmol of methyl methacrylate, 7.85 mL of MAO (1.53 mol/L) under stirring, where Al/Ni mole ratio is 300:1; continuing to feed ethylene until the pressure is 5 MPa and performing reaction for 1 h, then stopping feeding ethylene;

2) relieving pressure; using a hydrochloric acid ethanol solution with a volume concentration of 5% for processing; then washing, filtering, and drying to obtain the copolymer of ethylene and methyl methacrylate.

### Comparative Embodiment 4

1. The main catalyst of the catalyst used for the copolymerization of ethylene and methyl methacrylate in the present comparative embodiment is compound 14, labeled as main catalyst Y₄.

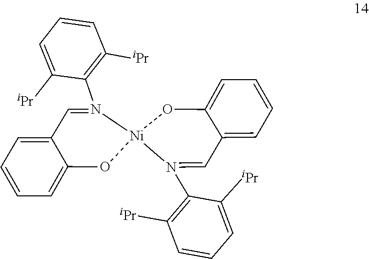

2. The preparation method of the ethylene of and methyl methacrylate copolymer in the present embodiment includes the following steps:

1) in a 150 mL clean and dry autoclave, adding 50 mL of toluene and 40 mol of the main catalyst Y₄ under an ethylene atmosphere; then feeding ethylene until the pressure is 0.05 MPa, and placing the reaction autoclave in an oil bath at 60° C. and performing electromagnetic stirring; adding 50 mmol of methyl methacrylate, 7.85 mL of MAO (1.53 mol/L) under stirring, where Al/Ni mole ratio is 300:1; continuing to feed ethylene until the pressure is 5 MPa and performing reaction for 1 h, then stopping feeding ethylene;

2) relieving pressure; using a hydrochloric acid ethanol solution with a volume concentration of 5% for processing; then washing, filtering, and drying to obtain the copolymer of ethylene and methyl methacrylate.

### Comparative Embodiment 5

1. The main catalyst of the catalyst used for the copolymerization of ethylene and methyl methacrylate in the present embodiment is compound 15, which is labeled as main catalyst Y₅.

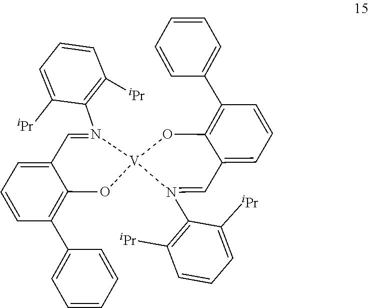

2. The preparation method of the copolymer of ethylene of and methyl methacrylate in the present embodiment includes the following steps:

1) in a 150 mL clean and dry autoclave, adding 50 mL of toluene and 40 mol of the main catalyst Y₅ under an ethylene atmosphere; then feeding ethylene until the pressure is 0.05 MPa, and placing the reaction autoclave in an oil bath at 45° C. and performing electromagnetic stirring; adding 47 mmol of methyl methacrylate, 3.9 mL of MAO (1.53 mol/L) under stirring, where Al/Ni mole ratio is 150:1; continuing to feed ethylene until the pressure reaches 3 MPa and performing reaction for 2 h, then stopping feeding ethylene;

2) relieving pressure; using a hydrochloric acid ethanol solution with a volume concentration of 5% for processing; then washing, filtering, and drying to obtain the copolymer of ethylene and methyl methacrylate.

For convenience of comparison, the copolymerization reaction conditions of the above embodiments and comparative embodiments are listed in Table 1.

### TEST EXAMPLES

Catalytic activity calculation is performed on the catalysts used for the copolymerization of ethylene and methyl methacrylate in Embodiments 1-35 and Comparative Embodiments 1-5, where the calculation formula is:

Catalytic activity=copolymer mass (g)/(addition amount of a main catalyst (mol)×reaction time (h)).

The copolymers of ethylene and methyl methacrylate of Embodiments 1-35 and Comparative Embodiments 1-5 are tested for the following parameters.

Determination method of molecular weight: the gel permeation chromatography (GPC, 2414) produced by American Waters Company is used for determination, a polystyrene standard sample being used for a calibration curve, a mobile phase being tetrahydrofuran, a column temperature being 40° C., a sample concentration being 1 mg/mL, an injection volume being 50 μL, an elution time being 40 min, and a flow rate being 1 mL·min⁻¹.

Measurement and calculation method of methyl methacrylate insertion rate: analyzing the ¹³C NMR of the copolymer using an American Bruker-400 MHz nuclear magnetic resonance instrument; according to a peak area of —CH₂ (chemical shift 1.27) and a peak area of —OCH₃ (chemical shift 3.56) on the ¹³C NMR spectrum, calculating a mole insertion rate of methyl methacrylate in the copolymer of ethylene and methyl methacrylate according to the following two formulas:

$$\frac{3 {N}_{M}}{A} = \frac{4 {N}_{E}}{B}$$

$$E = \frac{1}{1 + {N}_{M} / {N}_{E}}$$

In the above two formulas, N_{M} is a mole number of methyl methacrylate in the copolymer, N_{E} is a mole number of ethylene in the copolymer, A is a peak area of —OCH₃ (chemical shift 3.56) in methyl methacrylate, and B is a peak area of —CH₂ (chemical shift 1.27) in ethylene, and E is the mole insertion rate of methyl methacrylate in the copolymer.

The test results of the above parameters are shown in Table 2.

TABLE 1

| | Main Catalyst | | | Methyl | | | | | | |
|---|---|---|---|---|---|---|---|---|---|---|
| | | | Mole ratio | methacrylate | | | Al/M | | | |
| | | | of (I) | amount/m | Co- | | mole | Copolymerization | Copolymerization | Copolymerization |
| | (I) | (II) | to (II) | mol | catalyst | Solvent | ratio | pressure/MPa | temperature/° C. | time/h |
| Embodiment | 1 | 2 | 1:49 | 50 | MAO | Toluene | 300:1 | 4 | 60 | 1 |
| 1 | | | | | | | | | | |
| Embodiment | 1 | 2 | 49:1 | 50 | MAO | Toluene | 300:1 | 4 | 60 | 1 |
| 2 | | | | | | | | | | |
| Embodiment | 1 | 2 | 1:1 | 50 | MAO | Toluene | 300:1 | 4 | 60 | 1 |
| 3 | | | | | | | | | | |
| Embodiment | 1 | 2 | 3:1 | 50 | MAO | Toluene | 300:1 | 4 | 60 | 1 |
| 4 | | | | | | | | | | |
| Embodiment | 1 | 2 | 1:1 | 50 | MAO | Toluene | 500:1 | 4 | 60 | 1 |
| 5 | | | | | | | | | | |
| Embodiment | 1 | 2 | 10:1 | 50 | MAO | Toluene | 300:1 | 4 | 60 | 1 |
| 6 | | | | | | | | | | |
| Embodiment | 1 | 2 | 1:10 | 50 | Aluminum | Toluene | 300:1 | 4 | 60 | 1 |
| 7 | | | | | sesquiethyl | | | | | |
| Embodiment | 1 | 2 | 1:1 | 50 | Aluminum | Dichloromethane | 300:1 | 5 | 60 | 1 |
| 8 | | | | | sesquiethyl | | | | | |
| Embodiment | 1 | 2 | 1:1 | 50 | Aluminum | Dichloroethane | 300:1 | 5 | 60 | 2 |
| 9 | | | | | sesquiethyl | | | | | |
| Embodiment | 1 | 2 | 1:1 | 50 | Aluminum | Dichloroethane | 300:1 | 5 | 60 | 2 |
| 10 | | | | | sesquiethyl | and toluene | | | | |
| | | | | | | (volume ratio | | | | |
| | | | | | | is 1:1) | | | | |
| Embodiment | 3 | 4 | 49:1 | 50 | MAO | Toluene | 300:1 | 3 | 40 | 1 |
| 11 | | | | | | | | | | |
| Embodiment | 3 | 4 | 1:49 | 50 | MAO | Toluene | 300:1 | 3 | 40 | 1 |
| 12 | | | | | | | | | | |
| Embodiment | 3 | 4 | 1:1 | 50 | MAO | Toluene | 300:1 | 3 | 40 | 1 |
| 13 | | | | | | | | | | |
| Embodiment | 3 | 4 | 30:1 | 50 | MAO | Toluene | 300:1 | 3 | 40 | 1 |
| 14 | | | | | | | | | | |
| Embodiment | 3 | 4 | 10:1 | 50 | Aluminum | Toluene | 300:1 | 2 | 40 | 2 |
| 15 | | | | | sesquiethyl | | | | | |
| Embodiment | 3 | 4 | 1:10 | 50 | Aluminum | Toluene | 500:1 | 2 | 40 | 2 |
| 16 | | | | | sesquiethyl | | | | | |
| Embodiment | 3 | 4 | 2:1 | 50 | Aluminum | n-hexane | 500:1 | 3 | 60 | 2 |
| 17 | | | | | sesquiethyl | | | | | |
| Embodiment | 3 | 4 | 1:1 | 50 | Aluminum | n-hexane and | 300:1 | 5 | 40 | 1 |
| 18 | | | | | sesquiethyl | dichloroethane | | | | |
| | | | | | | (volume ratio | | | | |
| | | | | | | is 1:1) | | | | |
| Embodiment | 3 | 4 | 1:1 | 60 | Aluminum | n-hexane and | 300:1 | 10 | 60 | 1 |
| 19 | | | | | sesquiethyl | dichloroethane | | | | |
| | | | | | | (volume ratio | | | | |
| | | | | | | is 1:2) | | | | |
| Embodiment | 3 | 4 | 1:1 | 30 | Aluminum | Dichloromethane | 300:1 | 5 | 80 | 1 |
| 20 | | | | | sesquiethyl | | | | | |
| Embodiment | 5 | 6 | 49:1 | 50 | Aluminum | Toluene | 300:1 | 5 | 60 | 2 |
| 21 | | | | | sesquiethyl | | | | | |
| Embodiment | 5 | 6 | 1:49 | 50 | Aluminum | Toluene | 300:1 | 5 | 60 | 2 |
| 22 | | | | | sesquiethyl | | | | | |
| Embodiment | 5 | 6 | 1:1 | 50 | Aluminum | Toluene | 300:1 | 5 | 60 | 2 |
| 23 | | | | | sesquiethyl | | | | | |
| Embodiment | 5 | 6 | 10:1 | 50 | Aluminum | Toluene | 300:1 | 5 | 60 | 2 |
| 24 | | | | | sesquiethyl | | | | | |
| Embodiment | 5 | 6 | 1:10 | 50 | Aluminum | Toluene | 300:1 | 5 | 60 | 2 |
| 25 | | | | | sesquiethyl | | | | | |
| Embodiment | 5 | 6 | 1:5 | 60 | MAO | Toluene | 300:1 | 5 | 40 | 2 |
| 26 | | | | | | | | | | |
| Embodiment | 5 | 6 | 1:5 | 60 | MAO | dichloroethane | 500:1 | 5 | 40 | 2 |
| 27 | | | | | | | | | | |
| Embodiment | 5 | 6 | 2:1 | 60 | MAO | Toluene | 500:1 | 3 | 80 | 2 |
| 28 | | | | | | | | | | |
| Embodiment | 5 | 6 | 2:1 | 60 | MAO | Dichloromethane | 500:1 | 3 | 80 | 4 |
| 29 | | | | | | and n-hexane | | | | |
| | | | | | | (volume ratio | | | | |
| | | | | | | is 1:3) | | | | |
| Embodiment | 5 | 6 | 1:1 | 30 | MAO | Dichloroethane | 500:1 | 5 | 60 | 6 |
| 30 | | | | | | | | | | |
| Embodiment | 7 | 8 | 1:1 | 50 | MAO | Toluene | 500:1 | 4 | 60 | 1 |
| 31 | | | | | | | | | | |
| Embodiment | 9 | 10 | 49:1 | 50 | MAO | Toluene | 300:1 | 3 | 40 | 1 |
| 32 | | | | | | | | | | |
| Embodiment | 11 | 12 | 49:1 | 50 | Aluminum | Toluene | 300:1 | 5 | 60 | 2 |
| 33 | | | | | sesquiethyl | | | | | |
| Embodiment | 1 | 2 | 1:1 | 50 | MAO | Toluene | 750:1 | 4 | 60 | 1 |
| 34 | | | | | | | | | | |
| Embodiment | 1 | 2 | 1:1 | 50 | MAO | Toluene | 2000:1 | 4 | 60 | 1 |
| 35 | | | | | | | | | | |
| Comparative | 5 | — | — | 30 | MAO | Toluene | 300:1 | 5 | 60 | 1 |
| Embodiment | | | | | | | | | | |
| 1 | | | | | | | | | | |
| Comparative | — | 6 | — | 30 | MAO | Toluene | 300:1 | 5 | 60 | 1 |
| Embodiment | | | | | | | | | | |
| 2 | | | | | | | | | | |
| Comparative | 13 | — | — | 50 | MAO | Toluene | 300:1 | 5 | 60 | 1 |
| Embodiment | | | | | | | | | | |
| 3 | | | | | | | | | | |
| Comparative | — | 14 | — | 50 | MAO | Toluene | 300:1 | 5 | 60 | 1 |
| Embodiment | | | | | | | | | | |
| 4 | | | | | | | | | | |
| Comparative | — | 15 | — | 47 | MAO | Toluene | 150:1 | 3 | 45 | 2 |
| Embodiment | | | | | | | | | | |
| 5 | | | | | | | | | | |

Note:
M represents the metal element in the main catalyst.

TABLE 2

| | | | Weight average | |
|---|---|---|---|---|
| | | Catalytic | molecular | Methyl |
| | | activity/ | weight of | methacrylate |
| | Copolymer | (gPolymer/ | copolymer/ | insertion |
| | mass/g | mol M · h) | (g/mol) | rate/mol % |
| Embodiment 1 | 8.4 | 2.1 × 10⁵ | 1.05 × 10⁵ | 15.8 |
| Embodiment 2 | 20.4 | 5.8 × 10⁵ | 2.85 × 10⁵ | 3.9 |
| Embodiment 3 | 19.2 | 4.8 × 10⁵ | 1.93 × 10⁵ | 11.6 |
| Embodiment 4 | 20 | 5.0 × 10⁵ | 2.43 × 10⁵ | 15.5 |
| Embodiment 5 | 72 | 1.8 × 10⁶ | 2.07 × 10⁵ | 10.2 |
| Embodiment 6 | 21.2 | 5.3 × 10⁵ | 2.2 × 10⁵ | 0.5 |
| Embodiment 7 | 4.8 | 1.2 × 10⁵ | 1.55 × 10⁵ | 6.2 |
| Embodiment 8 | 12.8 | 3.2 × 10⁵ | 1.61 × 10⁵ | 16.2 |
| Embodiment 9 | 42.4 | 5.3 × 10⁵ | 2.84 × 10⁵ | 9 |
| Embodiment 10 | 22.4 | 2.8 × 10⁵ | 3.1 × 10⁵ | 9.1 |
| Embodiment 11 | 284 | 7.1 × 10⁶ | 6.41 × 10⁵ | 3.2 |
| Embodiment 12 | 30 | 3.5 × 10⁵ | 3.27 × 10⁵ | 17.6 |
| Embodiment 13 | 30 | 7.5 × 10⁵ | 5.11 × 10⁵ | 15.5 |
| Embodiment 14 | 26 | 6.5 × 10⁵ | 5.59 × 10⁵ | 5.6 |
| Embodiment 15 | 68 | 8.5 × 10⁵ | 6.93 × 10⁵ | 4.7 |
| Embodiment 16 | 296 | 3.7 × 10⁶ | 4.56 × 10⁵ | 17.2 |
| Embodiment 17 | 48.8 | 6.1 × 10⁵ | 4.26 × 10⁵ | 14.5 |
| Embodiment 18 | 6.8 | 1.7 × 10⁵ | 4.56 × 10⁵ | 10.2 |
| Embodiment 19 | 14.8 | 3.7 × 10⁵ | 4.87 × 10⁵ | 12.4 |
| Embodiment 20 | 5.2 | 1.3 × 10⁵ | 4.49 × 10⁵ | 10.7 |
| Embodiment 21 | 92 | 1.1 × 10⁶ | 2.18 × 10⁵ | 3.7 |
| Embodiment 22 | 8 | 1.0 × 10⁵ | 1.05 × 10⁵ | 13.7 |
| Embodiment 23 | 26.4 | 3.3 × 10⁵ | 1.28 × 10⁵ | 13.5 |
| Embodiment 24 | 92 | 1.1 × 10⁶ | 1.99 × 10⁵ | 2.4 |
| Embodiment 25 | 71.2 | 8.9 × 10⁵ | 1.99 × 10⁵ | 12.4 |
| Embodiment 26 | 9.2 | 1.15 × 10⁵ | 1.18 × 10⁵ | 10.1 |
| Embodiment 27 | 8.8 | 1.1 × 10⁵ | 1.05 × 10⁵ | 12.1 |
| Embodiment 28 | 58.4 | 7.3 × 10⁵ | 1.16 × 10⁵ | 6.7 |
| Embodiment 29 | 116.8 | 2.3 × 10⁵ | 1.26 × 10⁵ | 5.7 |
| Embodiment 30 | 136.8 | 5.7 × 10⁵ | 1.02 × 10⁵ | 11.6 |
| Embodiment 31 | 368 | 9.2 × 10⁶ | 3.15 × 10⁵ | 11.7 |
| Embodiment 32 | 324 | 8.1 × 10⁶ | 2.41 × 10⁵ | 2.7 |
| Embodiment 33 | 376 | 4.7 × 10⁶ | 2.02 × 10⁵ | 4.1 |
| Embodiment 34 | 17.2 | 4.3 × 10⁵ | 1.59 × 10⁵ | 10.2 |
| Embodiment 35 | 16.4 | 4.1 × 10⁵ | 1.03 × 10⁵ | 9.6 |
| Comparative | 250 | 6.25 × 10⁶ | 5.1 × 10⁴ | 1.6 |
| Embodiment 1 | | | | |
| Comparative | 4 | 1 × 10⁵ | 1.0 × 10⁴ | 15.8 |
| Embodiment 2 | | | | |
| Comparative | 0.48 | 1.2 × 10⁴ | 1.02 × 10⁴ | 3.1 |
| Embodiment 3 | | | | |
| Comparative | 0.21 | 5.1 × 10³ | 7.0 × 10³ | 52 |
| Embodiment 4 | | | | |
| Comparative | — | 3.34 × 10⁴ | 6.41 × 10⁴(number | 70.1 |
| Embodiment 5 | | | average) | |

It can be seen from the data in Table 2 that when the catalyst of the present application is used for the copolymerization of ethylene and methyl methacrylate, a copolymer of ethylene and methyl methacrylate with a higher molecular weight can be obtained.

The above embodiments are only used to illustrate the technical solutions of the present application, and are not intended to limit them; although the present application has been described in detail with reference to the foregoing embodiments, those of ordinary skill in the art should understand that: the technical solutions described in the foregoing embodiments can still be modified, or some or all of the technical features thereof can be equivalently replaced; and these modifications or replacements do not make the essence of the corresponding technical solutions depart from the scope of the technical solutions of the embodiments of the present application.

What is claimed is:

1. A catalyst for copolymerization of ethylene and methyl methacrylate, wherein the catalyst comprises a main catalyst, and the main catalyst is obtained by compounding a compound of formula (I) and a compound of formula (II);
a structure of the compound of formula (I) is: 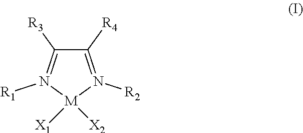
wherein, R₁ and R₂ are each independently selected from substituted aryl, a substituent being selected from at least one of C1-C6 alkyl and C1-C6 alkoxy;
R₃ and R₄ are each independently selected from hydrogen and C1-C4 alkyl;
M is selected from Ni or Pd;
X₁ and X₂ are each independently selected from at least one of halogen, C1-C4 alkyl, aryl, C2-C4 ether and C1-C4 nitrile;
a structure of the compound of formula (II) is: 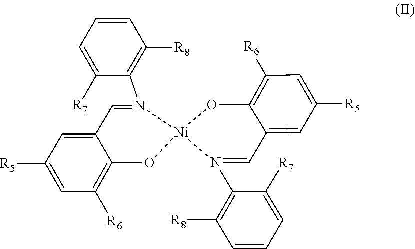
wherein, R₅ and R₆ are each independently selected from at least one of hydrogen, methyl, ethyl, dimethylamino, diethylamino, amino, hydroxyl, and C1-C4 alkoxy;
R₇ and R₈ are each independently selected from at least one of hydrogen, C1-C4 alkyl, C1-C4 dialkylamino, amino, hydroxyl, and C1-C4 alkoxy;
a mole ratio of the compound of formula (I) to the compound of formula (II) is (1:49) to (49:1).

2. The catalyst according to claim 1, wherein the mole ratio of the compound of formula (I) to the compound of formula (II) is (1:10) to (10:1).

3. The catalyst according to claim 1, wherein the catalyst further comprises a co-catalyst selected from aluminoxane.

4. The catalyst according to claim 3, wherein the co-catalyst is selected from at least one of methylaluminoxane, trialkylaluminum, and alkylaluminium halide.

5. The catalyst according to claim 3, wherein a mole ratio of metal element in the main catalyst to aluminum element in the co-catalyst is 1:(50-1000).

6. The catalyst according to claim 5, wherein the mole ratio of the metal element in the main catalyst and the aluminum element in the co-catalyst is 1:(100-500).

7. A copolymerization method of ethylene and methyl methacrylate, adopting the catalyst according to claim 1.

8. The copolymerization method according to claim 7, wherein the copolymerization method comprises: subjecting ethylene and methyl methacrylate to a copolymerization reaction under a catalysis of the catalyst;
a pressure of the copolymerization reaction is ≤10 MPa, and a temperature of the copolymerization reaction is ≤100° C.

9. The copolymerization method according to claim 8, wherein a solvent of the copolymerization reaction is selected from at least one of toluene, n-hexane, dichloromethane, and dichloroethane.

10. A copolymer of ethylene and methyl methacrylate, wherein the copolymer is prepared by the copolymerization method according to claim 7, and has a weight average molecular weight of ≥1×10⁵ g/mol.
